(19) United States
(12) Patent Application Publication
(10) Pub. No.: US 2025/0308724 A1
(43) Pub. Date: Oct. 2, 2025

(54) FLEXIBLE ELECTRICAL CONDUCTOR COMPRISING ELEMENTS CONNECTED TO ONE ANOTHER BY TIG WELDING, AND METHOD FOR MANUFACTURING SUCH A FLEXIBLE ELECTRICAL CONDUCTOR

(71) Applicant: COMMISSARIAT A L'ENERGIE ATOMIQUE ET AUX ENERGIES ALTERNATIVES, Paris (FR)

(72) Inventors: Simon ALAMOME, Grenoble Cedex 09 (FR); Geraud CUBIZOLLES, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 18/866,232

(22) PCT Filed: May 17, 2023
(86) PCT No.: PCT/FR2023/050711

§ 371 Date: Nov. 15, 2024

(30) Foreign Application Priority Data
May 18, 2022 (FR) FR2204723

(51) Int. Cl. H01B 7/04; H01B 1/02; H01B 7/00; H01B 7/20; H01B 13/22; H01M 8/02

(52) U.S. Cl. CPC H01B 7/04; H01B 1/02; H01B 7/0018; H01B 7/20; H01B 13/228; H01M 8/02

(57) ABSTRACT

A flexible electrical conductor including an assembly comprising a flexible conductive core made of a first metal material and a sheath covering the conductive core and made of a second metal material having an electrical resistivity higher than the electrical resistivity of the first metal material; a first connection strip formed at least in part by the second metal material and connected to a first end of the assembly, wherein, at the first end of the assembly, the sheath and the first connection strip are bonded by TIG welding, and the conductive core and the first connection strip are bonded by fillet-brazing or soldering.

### TECHNICAL FIELD

The present invention relates to the general field of high-temperature electrolysis (HTE), in particular high-temperature steam electrolysis (HTSE), carbon dioxide (CO₂) electrolysis, and even high-temperature co-electrolysis of steam and carbon dioxide (CO₂).

More specifically, the invention relates to the field of high-temperature electrochemical devices, such as high-temperature solid oxide electrolysis cells or SOEC for short, and high-temperature solid oxide fuel cells or SOFC for short, but also high-temperature co-electrolysers of steam and carbon dioxide, reversible fuel cell and high-temperature electrolyser systems, or medium-temperature cells or electrolysers, of the order of 400° C., called proton ceramic fuel cells or PCFC for short.

Thus, more generally, the invention refers to the field of stacks of solid oxide cells of the SOEC/SOFC type operating at high temperature. The stacks may operate at atmospheric pressure or under pressure.

Beyond such stacks of solid oxide cells of the SOEC/SOFC type, the invention relates to any system where there is a need for electrical conduction in an oxidising environment at high temperature or in conditions resulting in the rapid deterioration of electrically conductive materials.

More specifically, the invention relates to supplying a stack of electrochemical cells with electric current in the hot area.

### PRIOR ART

In a high-temperature solid oxide electrolysis cell or SOEC, steam (H₂O) is transformed into dihydrogen (H₂), or other fuels such as methane (CH₄), natural gas, biogas, and dioxygen (O₂), and/or carbon dioxide (CO₂) is transformed into carbon monoxide (CO) and dioxygen (O₂) by means of an electric current, within the same electrochemical device. In a high-temperature solid oxide fuel cell or SOFC, the operation is reversed to produce an electric current and heat by being supplied with dihydrogen (H₂) and dioxygen (O₂), typically air and natural gas, namely methane (CH₄). For the sake of simplicity, the following description favours the operation of a high-temperature solid oxide electrolysis cell or SOEC carrying out the electrolysis of steam. However, this operation is applicable to the electrolysis of carbon dioxide (CO₂), or even to the high-temperature co-electrolysis of steam (HTSE) and carbon dioxide (CO₂). In addition, this operation can be transposed to the case of a high-temperature solid oxide fuel cell or SOFC.

As known per se, a high-temperature steam (H₂O) electrolyser or HTSE comprises a stack of a plurality of elementary solid oxide electrochemical cells. With reference to FIG. 1, a solid oxide cell 10 or SOC comprises in particular: a) a first porous conductive electrode 12, or “cathode”, intended to be supplied with steam for the production of dihydrogen; b) a second porous conductive electrode 14, or “anode”, via which the dioxygen (O₂) produced by the electrolysis of the water injected at the cathode escapes; and c) a solid oxide membrane (dense electrolyte) 16 sandwiched between the cathode 12 and the anode 14, the membrane 16 being an anionic conductor for high temperatures, usually temperatures greater than 600° C.

By heating the cell 10 to at least this temperature and injecting an electric current/at the anode 14, the water at the cathode 12 is reduced, generating dihydrogen (H₂) at the cathode 12 and dioxygen (O₂) at the anode 14.

A stack 20 of such cells with the aim of producing a large quantity of dihydrogen is shown in the schematic view in FIG. 2. In particular, the cells 10 are stacked on top of one another, separated by interconnecting plates 18 or interconnectors. The function of these plates is both to ensure electrical continuity between the various electrodes of the cells 10, thus enabling them to be connected in electrical series, and to distribute the various gases required for the cells to operate, as well as, if necessary, a carrier gas to help evacuate the products of electrolysis and/or provide thermal management of the stack.

To do this, the plates 18 are connected to a supply 22 of steam for injection of this steam at the cathodes of the cells 10 in accordance with a constant steam flow rate D_{H2O} set by a controllable valve 24. The plates 18 are also connected to a gas collector 26 for collecting gases from electrolysis. An exemplary stack and interconnecting plate structure are, for example, described in the international application WO 2011/110676 A1.

In order to effectively implement electrolysis by the stack 20, the stack is heated to a temperature greater than 600° C., usually a temperature comprised between 650° C. and 900° C., the gas supply is switched on at a constant flow rate and an electrical power source 28 is connected between two terminals 30, 32 of the stack 20 to circulate a current/there.

The intensity of the electric current/is usually of the order of a few hundred amperes, which generates significant heat losses by the Joule effect in electrical conductors. In order to optimise the energy efficiency of solid oxide electrochemical systems, it is important to limit these thermal losses by developing in particular specific electrical conductors also known as busbars.

A busbar in the stack usually takes the form of a metal rod. Taking the example of a cylindrical rod, the electrical resistance R can be expressed by the following formula:

$$R = ρ \cdot \frac{l}{S}$$

where ρ is the resistivity of the rod (in Ω·m), l is the length of the rod (in m) and S is the cross-section of the rod in m²).

As the losses by Joule effect are proportional to the resistance R, in order to limit this effect, it is therefore necessary to reduce the electrical resistance of the busbar.

Possible improvements therefore involve:
limiting the length of the rod,
increasing its cross-section,
finding a material with a lower resistivity that is stable at high temperatures.

The first two options are geometric choices that generally depend on the shape of the electrochemical system. There are therefore constraints on them and/or the rods in the prior art are already optimised for the electrochemical system. The last point relates to the constituent material of the rod that has to be chosen with minimum resistivity to reduce ohmic losses.

Improving this last point has not been sufficiently considered. In fact, for all laboratory developments of the technology, energy efficiency is not of prime importance. On the other hand, as explained below, a rod is immersed in a highly corrosive environment, so the standard solution used is to use solid stainless alloy rods, which are therefore the reference solution in all international publications. While the resistivity of these rods at room temperature (20° C.) is already high, around 75.10⁻⁸ Ω·m, it should be noted that this resistivity increases sharply with temperature.

Thus, at 900° C., which is a high operating temperature for a solid oxide electrolysis cell, the electrical resistance of a stainless steel rod is equal to 117.10⁻⁸ Ω·m, which results in a very significant ohmic loss. These aspects have in particular been described in the French patent application FR 3 036 840 A1.

However, if the aim is to optimise electrical resistivity, the material generally recommended for electrical conductors subjected to a high intensity of electric current is copper. An experimental study carried out by the Applicant determined the resistivity curve of copper as a function of temperature and confirmed that the choice of copper makes it possible to reduce ohmic losses by at least a factor of 10 compared to the reference material over the entire range of operating temperatures for solid oxide systems.

However, one of the major constraints to be taken into consideration is the issue of corrosion linked to the environment of the stack.

With reference to FIG. 3, the stack 20 is in fact enclosed in a so-called “thermal” enclosure, the temperature of which is kept between 65° and 900° C. with the application of sweep air, a conventional electrochemical system thus comprising:
the HTS electrolyser 20, for example the one described in relation to FIGS. 1 and 2 and comprising a set of conduits 52, 54, 56, 58 for supplying and collecting the gases from the anodes and cathodes of the electrochemical cells of the electrolyser;
an enclosure 60 in which the electrolyser 20 is housed, the conduits 52, 54, 56, 58 passing through a wall of the enclosure 60 for their connection to gas collection and supply circuits (not shown). The enclosure 60 also has an air inlet conduit 62, and an air outlet conduit 64, the enclosure 60 being, for example, hermetically sealed against gases and liquids everywhere else. The conduit 62 is able to be connected to an air supply circuit (not shown) so as to apply sweep air to the hot area surrounding the electrolyser 20, the sweep air being discharged through the outlet conduit 64; and
two electrical conductors 66, 68 connected to the terminals 30, 32 of the stack 20 and passing through the enclosure 60 for their connection to the current source 28.

In these conditions, two conductors 66, 68 in the form of a copper rod, part of which at least is included in the enclosure 60, will oxidise very quickly. In addition, the copper does not resist oxidation at high temperatures because the oxide formed at the surface is not sufficiently tight and adherent to protect the underlying metal. Materials known to resist oxidation at high temperatures are chromium and aluminium forming alloys such as stainless steels and stainless nickel alloys as these form chromia and/or alumina, which are much more protective oxides. However, as has been mentioned above, these alloys have an electrical resistivity such that their use results in significant energy losses.

A high-temperature solid oxide fuel cell or SOFC encounters similar issues. In fact, a HTS electrolyser and an SOFC are identical structures, the only difference being their operating mode, with the electrolyser operating in carbon dioxide (CO₂) reduction mode or in co-electrolysis mode, i.e. with a gas mixture at the cathode inlet consisting of steam (H₂O) and carbon dioxide (CO₂). The mixture at the cathode outlet is therefore composed of hydrogen (H₂), steam (H₂O), carbon monoxide (CO) and carbon dioxide (CO₂). With reference to FIG. 4, an electrochemical cell making up an SOFC comprises the same elements (anode 12, cathode 14, electrolyte 16) as an electrolysis cell, the cell however being supplied, with constant flow rates, at its anode with dihydrogen and at its cathode with dioxygen, and connected to a load C to deliver the electric current produced. With regard to the electric current produced, of several amperes, the cell therefore encounters the same issues as the electrolyser.

One solution would be to protect a copper rod (or any other metal deemed suitable in terms of electrical resistivity) with a coating to give it a good level of resistance to oxidation, for example a chromia or alumina coating. This poses several problems. Firstly, it is necessary to ensure that the coating is tight and remains on the copper substrate during heating. It should be highlighted that as copper has a high coefficient of thermal expansion, significant differential thermal expansion stresses may occur and damage the coating and/or the coating/copper interface. In addition, at the hot end of the rod, an electrical connection needs to be made to the stack without exposing the copper. The connection therefore has to be made on the coating without damaging it, which is technically challenging.

Another solution is to encase the copper road in a sheath made of an oxidation-resistant material. This solves the issue of resistance to the differential thermal expansion stresses as the two materials are not integral. Such an assembly (copper+stainless steel sheath) is already known from the prior art for other fields of application (e.g. a strong acid environment at low temperature, 50-80° C.), in particular from the Chinese document CN 202608143 U which describes a copper bar which is simply inserted into a steel tube. This type of conductor is satisfactory at low temperatures, but it has been found to be unsuitable for solid oxide systems. In fact, the little contact between the conductive core and sheath results in, given the high temperature, a deterioration in the electrical contact between the two materials and an increase in ohmic losses. In other words, there is no optimised electrical conduction system in the prior art that is suitable for a high electric current and can withstand significant thermal cycling in an oxidising environment.

Patent application FR 3 036 840 A1 discloses an electrical conductor suitable for currents of several hundred amperes, resistant to oxidation at high temperatures and that withstands the thermal cycle up to 900° C. This electrical conductor comprises a rod made of a first metal material and a sheath, completely covering the rod, made of a second metal material, the two being welded together by means of hot isostatic pressing (HIP).

More specifically, this application proposes shaping a rod consisting of a copper round core protected by a tube sheath of Inconel® 600 steel, with a part called the “whistle” made of Inconel® 600 steel which is the connection terminal, and a closing end-piece also made of Inconel® 600 steel through which a vacuum is drawn. These parts are assembled by TIG (Tungsten Inert Gas) type arc welding. The resulting rod is then subjected to a hot isostatic pressing (HIP) process, which enables the various materials to be diffusion welded together without the addition of filler metal.

However, this solution has several drawbacks, and in particular the use of hot isostatic pressing (HIP) which is an onerous method which can only be carried out by certain companies, given a temperature and high pressure cycle of around 900° C. and 1000 bar, with a cycle time of a few hours.

In addition, the busbar consists of a single high-temperature connection area, which does not allow for internal connections to be made in the high-temperature area.

### DISCLOSURE OF THE INVENTION

The invention aims to at least partially address the aforementioned needs and the drawbacks relating to the embodiments of the prior art.

The object of the invention is therefore, according to one of its aspects, a flexible electrical conductor, including:
an assembly comprising:
a flexible conductive core made of a first metal material,
a sheath covering the conductive core and made of a second, in particular stainless or refractory, metal material having an electrical resistivity higher than the electrical resistivity of the first metal material,
a first connection strip formed at least in part by the second metal material and connected to a first end of the assembly, characterised in that, at the first end of the assembly, the sheath and the first connection strip are bonded by TIG (Tungsten Inert Gas) welding, in particular over the entire circumference, and the conductive core and the first connection strip are bonded by fillet-brazing or soldering, in particular high-temperature fillet-brazing or soldering.

The sheath and the first connection strip can be bonded by TIG welding preferably with an addition of material made of the second metal material. However, the material could also be added by a stainless or refractory metal, and/or metal or refractory alloys, in particular stainless or refractory steel. The filler material is advantageously resistant to oxidation at high temperatures and compatible with the materials used for the sheath and connection strip.

“Flexible” electrical conductor is understood as a conductor used for connection to the stack, able to avoid the transmission of vibrations, expansion and other parasitic motions between the stack and its environment (for example the furnace hearth, the frame, the gas pipelines, etc.) and enabling a possible electrical connection to be established between stacks during assembly without mechanical transition, as opposed to a “rigid” electrical conductor acting mechanically within a main link and not directly connected to a stack. The flexibility of a flexible electrical conductor makes wiring easier, particularly at the stack level. It also makes it possible to adapt to different shapes. For a flexible electrical conductor, the shaping torque is less than 2 N·m, whereas for a rigid electrical conductor, it is greater than 10 N·m.

The electrical conductor according to the invention may also include one or several of the following characteristics in isolation or according to any possible technical combinations.

The electrical conductor can advantageously have a second connection strip formed at least in part by the second metal material and connected to a second end of the assembly. At the second end of the assembly, the sheath and the second connection strip can be bonded by TIG welding, in particular with an addition of material made of the second metal material, and the conductive core and the second connection strip can be bonded by fillet-brazing or soldering. The TIG welds at the two ends of the assembly and the sheath can completely covering the conductive core over its entire length.

Furthermore, at least one gap can be present between the outer surface of the conductive core and the inner surface of the sheath over at least part of the length of the conductive core.

The conductive core, first metal material, can be made of copper, nickel or silver and/or copper, nickel or silver alloys, or any other metal or alloy with good electrical conductivity. In particular, any other metal or alloy with good electrical conductivity sensitive to oxidation at high temperatures, of the order of 900° C., such as brass or bronze.

In addition, the sheath, second metal material, can be made of stainless or refractory metal and/or metal or refractory alloys, in particular stainless or refractory steel, for example made of nickel, chromium or cobalt, in particular Inconel®, for example Inconel® 600 or 625, or any other metal or alloy resistant to oxidation at high temperatures, for example 316L stainless steel.

The first connection strip and/or the second connection strip can be made entirely of the second metal material.

Alternatively, in order to limit any electrical losses, the first connection strip and/or the second connection strip can each have a conductive connection core made of the first metal material, and a connection sheath completely covering the connection core over its entire length and made of the second metal material.

The connection sheath can be around 0.5 mm thick.

According to one specific embodiment aiming in particular at obtaining a flexible and electrically insulated power cable, the assembly comprising the conductive core and the sheath can be flexible, in particular the conductive core and the sheath being made of a flexible material and the sheath being completely covered by an electrically insulating jacket, or electrically insulating protection, in particular a ceramic braided jacket.

Furthermore, another object of the invention, according to another of its aspects, is a method for manufacturing an electrical conductor as defined above, characterised in that it has the following steps:
cleaning the surfaces, in particular using a detergent and/or a solvent, in particular surfaces intended to be welded, i.e. the electrical conduction surfaces and the surfaces required to seal the electrical conductor,
inserting the conductive core into the sheath,
bonding the conductive core to the first connection strip by fillet-brazing or soldering,
bonding the sheath to the first connection strip by TIG welding,
if necessary, evacuating the sheath by pumping.

The electrical conductor can have a second connection strip formed at least in part by the second metal material and connected to a second end of the assembly, and the method may include, after the step of bonding the sheath to the first connection strip by TIG welding, the following steps:
bonding the conductive core to the second connection strip by fillet-brazing or soldering,
bonding the sheath to the second connection strip by TIG welding.

Manufacturing can be carried out in an ambient atmosphere (air) or in a neutral atmosphere, such as argon.

The first connection strip and/or the second connection strip can be formed by assembling a conductive connection core and a connection sheath completely covering the connection core. The connection core can be manufactured by die-forging. However, methods other than die-forging could be used, such as machining or forging. The connection sheath can be manufactured by deep-drawing or assembling a plurality of parts made of the second metal material.

Furthermore, assembling the first connection strip and/or the second connection strip may include at least the following steps:
cleaning the constituent elements of the connection strip, in particular using a detergent or a solvent,
inserting the connection core into the connection sheath,
evacuating the connection strip,
applying a diffusion welding cycle by hot isostatic pressing (HIP).

The diffusion welding cycle by hot isostatic pressing (HIP) can be carried out with the following operating conditions:
heating the assembly formed by the connection core and the connection sheath to a temperature comprised between 600° C. and 1060° C., preferably between 800° C. and 1000° C., in particular a temperature of 920° C.,
applying a pressure comprised between 500 bar and 1500 bar, preferably between 800 bar and 1200 bar, in particular a pressure of 1020 bar, to the connection sheath,
applying a pressure and temperature plateau for a period of 30 minutes to several hours, preferably 1 hour to 3 hours, in particular 2 hours,
allowing the assembly to cool and depressurising.

In addition, in order to guarantee good electrical conductivity, the conductive core and the connection core of the first connection strip and/or of the second connection strip can be joined together by a method of high-temperature brazing or soldering.

In addition, another object of the invention, according to another of its aspects, is the use of at least one electrical conductor as defined above, as electrical conductor of an electrochemical system including:
an enclosure for the circulation of air in the volume delimited thereby,
an electrochemical device housed in the enclosure, comprising:
a high-temperature SOEC/SOFC-type solid oxide stack of elementary electrochemical cells each comprising an electrolyte interposed between a cathode and an anode and connected in series between two electrical terminals, and
said at least one electrical conductor connected to at least one of the two electrical terminals.

Moreover, another object of the invention, according to another of its aspects, is an system having: electrochemical
an enclosure for the circulation of air in the volume delimited thereby,
an electrochemical device housed in the enclosure, comprising:
a high-temperature SOEC/SOFC-type solid oxide stack of elementary electrochemical cells each comprising an electrolyte interposed between a cathode and an anode and connected in series between two electrical terminals, and
at least one electrical conductor as defined above connected to at least one of the two electrical terminals.

### BRIEF DESCRIPTION OF THE DRAWINGS

The invention will be better understood upon reading the following detailed description of non-limiting exemplary embodiments thereof, as well as upon examining the schematic and partial figures of the appended drawing, wherein:

FIG. 1 is a schematic view of an elementary electrochemical cell of a HTS electrolyser,

FIG. 2 is a schematic view of a stack of cells according to [FIG. 1],

FIG. 3 is a schematic view of a system incorporating a stack according to [FIG. 2],

FIG. 4 is a schematic view of an electrochemical cell of a SOFC,

FIG. 5 is a schematic view of a flexible electrical conductor according to the invention,

FIG. 6 is a schematic cross-sectional view along the plane VI-VI shown in [FIG. 5],

FIG. 7 is a schematic view of another flexible electrical conductor according to the invention,

FIG. 8 is a schematic cross-sectional view along the plane VIII-VIII shown in [FIG. 7],

FIG. 9 is an enlarged view of A shown in [FIG. 8],

FIG. 10 is an exploded, perspective view of a connection strip of the electrical conductor shown in [FIG. 7],

FIG. 11 is an assembled, perspective view of a connection strip of the electrical conductor shown in [FIG. 7].

In all of these figures, identical reference numerals may designate identical or similar elements.

In addition, the various parts shown in the figures are not necessarily to scale, to make the figures more readable.

### DETAILED DESCRIPTION OF THE EMBODIMENTS

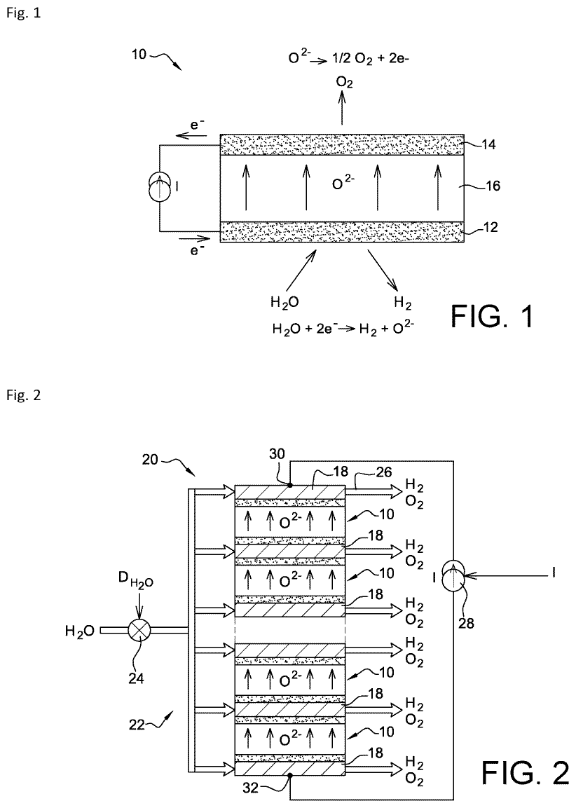

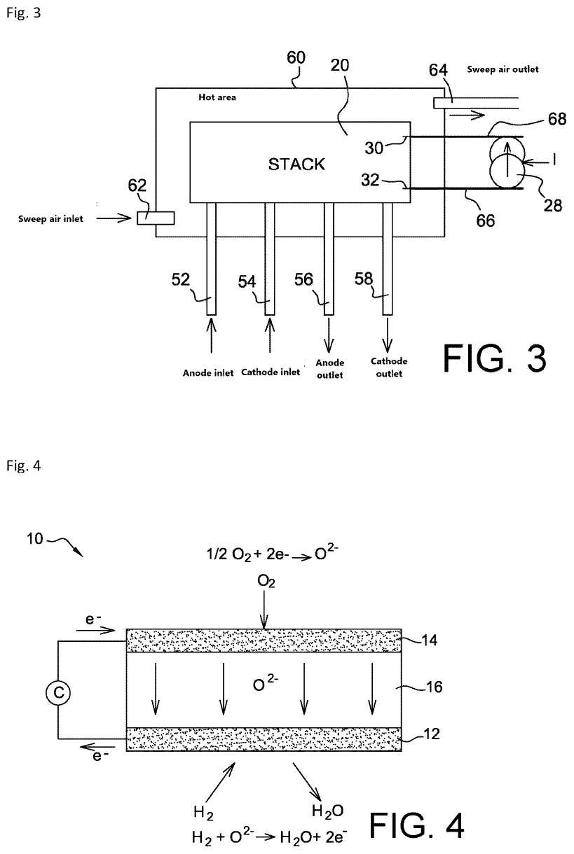

FIGS. 1 to 4 have already been described above in the part relating to the prior art and within the technical background of the invention.

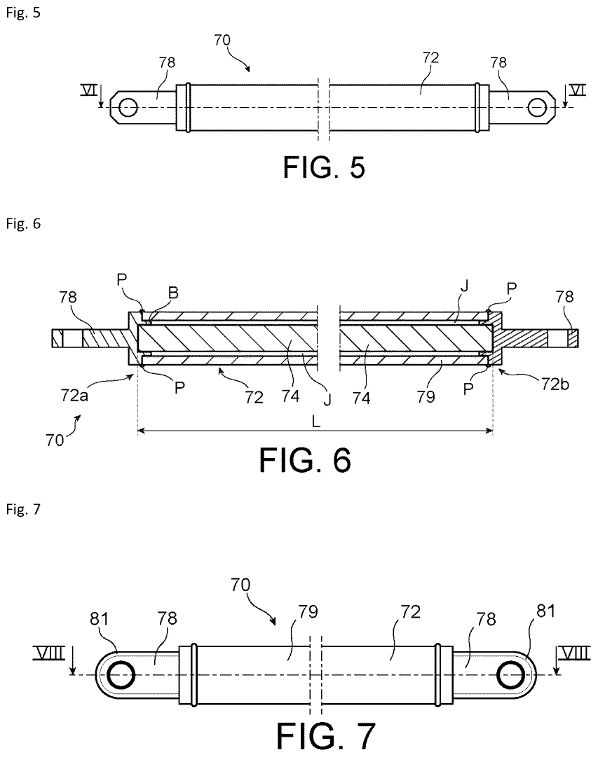

With reference to FIGS. 5 to 11, exemplary flexible electrical conductors 70 in the form of flexible power cables are shown. Such a flexible connection, for example, facilitates wiring and absorbs expansion or vibrations, inter alia.

With reference to FIGS. 5 and 6, an exemplary flexible electrical conductor 70 according to the invention is described. It thus has an assembly 72 consisting of a conductive core 74 made of a first metal material, in this case copper, inserted into a sheath 79, made of a second metal material, in this case stainless alloy, having an electrical resistivity higher than the electrical resistivity of the first metal material.

It should be noted that the conductive core 74 is made of copper in this case but the invention applies to other metals that are good electrical conductors but sensitive to oxidation, for example nickel, silver, brass, bronze and/or copper alloys, such as those hardened by dispersoids.

Moreover, the electrical conductor 70 has a first connection strip 78 formed by the second metal material and connected to a first end 72a of the assembly 72, and a second connection strip 78 formed by the second metal material and connected to a second end 72b of the assembly 72.

The connection strips 78, or “whistles”, in this case made of Inconel® stainless alloy, hermetically seal the ends 72a and 72b of the assembly 72, thus preventing the passage of gas. They are used to create the electrical connection terminals. They have a complementary shape to the plate of the electrolyser to which the strips 78 are attached for the electrical connection of the electrolyser.

The shape or geometry of the connection strips 78 may be the usual terminal shape, as shown here, or any other different shape, for example cylindrical and intended to fit into a bore or clamped between two half-shells secured to the device to be powered.

At the first end 72a of the assembly 72, the sheath 79 and the first connection strip 78 are bonded by TIG welding over the entire circumference, shown by P in FIG. 6, for example orbital welding, with an addition of material preferably made of the second metal material. The conductive core 74 and the first connection strip 78 are for their part bonded by fillet-brazing or soldering, shown by B in FIG. 6. The conductive core 74 and the sheath 79 are not welded together.

Similarly, at the second end 72b of the assembly 72, the sheath 79 and the second connection strip 78 are bonded by TIG welding (reference P) with an addition of material preferably made of the second metal material. The conductive core 74 and the second connection strip 78 are for their part bonded by fillet-brazing or soldering (reference B). The TIG welds at the two ends 72a and 72b of the assembly 72 and the sheath 79 completely cover the conductive core 74 over its entire length L, as shown in FIG. 6. The conductive core 74 and the sheath 79 are not welded together. TIG welding protects the conductor core 74 from oxidation. In fact, welding is carried out to seal the connections between the whistles 78 and the sheath 79.

As shown schematically in FIG. 6, one or more gaps J can be present between the outer surface of the conductive core 74 and the inner surface of the sheath 79 over at least part of the length L of the conductive core 74. In particular, atmosphere can be trapped between the conductive core 74 and the sheath 79, for example air, or an inerting atmosphere, for example argon.

In the event of air trapped between the sheath 79 and the conductive core 74, during use, in particular at high temperatures, this air will be consumed by the oxidation of the copper and that of the Inconel®, but as the volume is small and non-renewable (weld sealing), the oxidation layer will remain very thin. If there is a neutral atmosphere, for example with argon sweeping, the formation of the oxidation layer can be avoided.

It is also possible to evacuate the assembly 72 via a tube added for this purpose. A degassing tube is therefore added at one end and the sheath is evacuated by pumping via the tube. Seal welding can then be carried out to maintain the vacuum permanently, making it possible to seal the tube hermetically and permanently. Such an evacuation step can also be used to check for leaks.

The stainless alloy of the sheath 79 and connection strips 78 is chosen depending on the thermal stresses to which the electrical conductor 70 is exposed. In particular, for a temperature range up to 900° C., the sheath 79 and strips 78 can be made of Inconel® 600. The conductive core 74 may have a diameter of around ten millimetres. However, the cross-section can be modified according to requirements, for example in terms of current, voltage drop, etc. The conductive core 74 can also consist, in whole or in part, of one or more multi-strand cables, for example consist of a multi-strand braid.

The invention thus proposes shaping a core 74 consisting of a copper core (or any other metal deemed satisfactory in terms of electrical resistivity) protected by a sheath 79 made of stainless or refractory metal, in particular stainless steel or stainless nickel alloy, all welded together by TIG welding with the presence of two connection strips 78. The invention can therefore be implemented without the use of a hot isostatic pressing (HIP) method to enable the assembly between the core 74, sheath 79 and connection strips 78.

The invention can therefore advantageously have reduced manufacturing costs, and also be simple to manufacture, even enabling shaping and lengthening directly at the site of use (shaping, cutting to length, whistle welding). The electrical conductor 70 may be used entirely in the high temperature area and also as a partition feedthrough to provide a link between the high temperature area and the ambient temperature area.

The method for manufacturing such an electrical conductor 70, intended to be used as an electrical conductor for supplying a current to an electrochemical system, for example the one shown in FIGS. 1 to 4, includes, for example, the following steps:
manufacturing the parts described above (core, sheath, strips),
cleaning the parts and in particular the surfaces intended to be welded, i.e. the electrical conduction surfaces and the surfaces required to seal the electrical conductor, using a detergent and/or a solvent, or any other means,
inserting the conductive core 74 into the sheath 79,
bonding the conductive core 74 to the first connection strip 78 by fillet-brazing or soldering,
bonding the sheath 79 to the first connection strip 78 by TIG welding,
bonding the conductive core 74 to the second connection strip 78 by fillet-brazing or soldering,
bonding the sheath 79 to the second connection strip 78 by TIG welding,
if necessary, evacuating the sheath 79 by pumping.

In addition, a step of X-raying the welds may be carried out to confirm the quality of the welds from a mechanical, electrical and sealing point of view.

The ends provided with the strips 78 are hot ends that can be drilled, as shown in FIGS. 5 and 6, perpendicular to the axis of the sheath 79, to be screwed onto the stack.

The TIG welds are advantageously made by a person skilled in the art, in particular for the weld between the copper and the Inconel® in order to ensure that a good electrical connection is obtained, and for the weld between the Inconel® and the Inconel® in order to ensure that a seal weld is obtained.

By comparing the resistance obtained for a 1 m electrical conductor 70, in Table 1 below, in the case of an electrical conductor 70 with a diameter of 12 mm made entirely of Inconel® 600 (prior art design) and in the case of an electrical conductor 70 with a diameter of 12 mm made with a sheath 79 of Inconel® 600 and a core 74 of copper (design in accordance with the invention), it can be seen that the invention enables electrical losses to be reduced by a factor of 10, at the operating temperature of 800° C.

TABLE 1

| | Resistance of | Resistance of |
|---|---|---|
| | Inconel ® 600 | Inconel ® 600 + |
| Temperature | conductor 70 | copper conductor 70 |
| (° C.) | (Ω) | (Ω) |
| 20 | 9.1 · 10⁻³ | 0.21 · 10⁻³ |
| 800 | 10 · 10⁻³ | 0.87 · 10⁻³ |

For this results in Table 1, the resistivity of copper is 17.24.10⁻⁹ Ω·m at low temperature (20° C.) and 70.10⁻⁹ Ω·m at 800° C. The resistivity of the Inconel® 600 is 1.03.10⁻⁶ Ω·m at low temperature (20° C.) and 1.13.10^{-6 Ω·m at} 800° C.

The electrical conductor 70 obtained according to the principle of the invention is thus an electrical conductor suited to the high temperature and the high current of SOEC/SOFC stacks. However, there may be electrical losses in the connection strips 78 and it is possible to modify the design of these connection strips 78 in order to limit these losses.

FIGS. 7 to 11 relate to another embodiment of an electrical conductor 70 according to the invention in which the connection strips 78 have a different design, being referred to as “high conductivity” connection strips 78 or whistles 78.

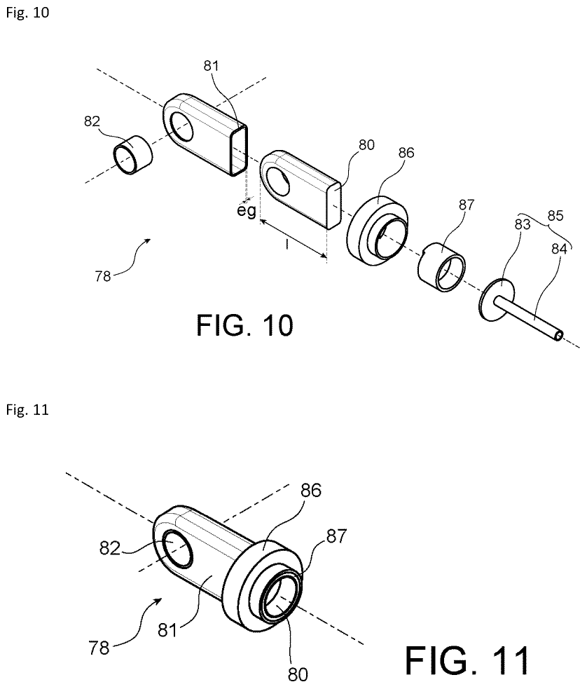

Specifically, the first connection strip 78 and the second connection strip 78 each have a conductive connection core 80 made of the first metal material, in this case copper but any other metal described above is possible, and a connection sheath 81 completely covering the connection core 80 over its entire length l, as shown in FIG. 10, and made of the second metal material, in this case Inconel® 600 but any other metal described above is possible. The connection sheath 81 is advantageously around 0.5 mm thick e_{g}, as seen in FIG. 10. Obtaining a low thickness e_{g} contributes significantly to reducing electrical losses.

In addition, each connection strip 78 has a tubular sleeve 82 inserted into corresponding holes of the connection core 80 and connection sheath 81 to enable attachment to the stack, as shown in FIGS. 10 and 11.

The connection strip 78 obtained, as shown in FIGS. 10 and 11, enables electrical losses therein to be reduced by replacing part of the second metal material with the first metal material having a good level of conductivity. In fact, by retaining an Inconel® connection sheath 81 to protect the copper connection core 80 from oxidation, it is possible to reduce the electrical losses of the whistle 78. However, as such a whistle 78 is the connection point, electrical continuity over the entire connection surface is required between the connection sheath 81 and the connection core 80. For this, the method for manufacturing such a whistle 78, described below, uses the hot isostatic pressing (HIP) method, only used in the invention to manufacture such “high conductivity” whistles 78, in order to guarantee a weld over the entire connection surface between the connection core 80 and the connection sheath 81.

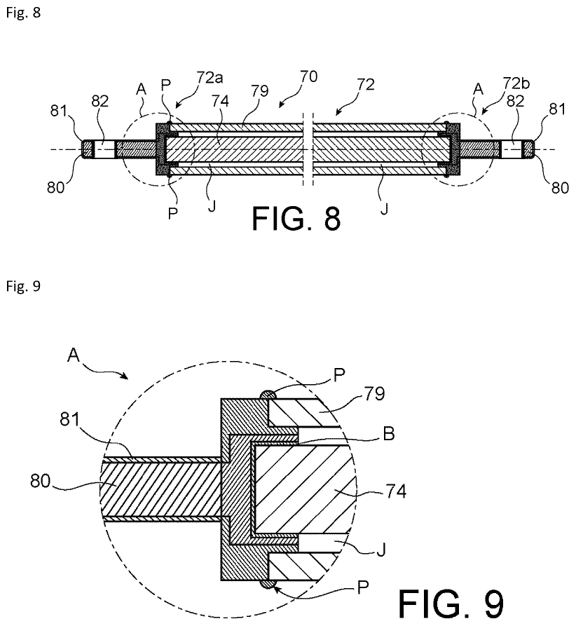

The electrical conductor 70 in the embodiment shown in FIGS. 7 and 8 therefore has a better level of conductivity than the one described with reference to FIGS. 5 and 6 thanks to the use of “high conductivity” connection strips 78. Specifically, a “high-conductivity” connection strip 78 can have a resistivity of only around ten percent compared to a connection strip 78 made completely of the second metal material.

To manufacture the “high conductivity” connection strips 78, the connection core 80 can be obtained by die-forging. Die-forging involves shaping raw parts made of alloys such as aluminium, copper, titanium, nickel, etc. by plastic deformation after heating. The die-stamping of steels is also known as “stamping”. Die-forging is a forging operation carried out using tools called “dies”, in particular upper and lower half-dies. These are embossed with the shape of the part to be manufactured.

Furthermore, the connection sheath 81 can be obtained by deep-drawing or assembling a plurality of parts made of the second metal material. This deep-drawing technique is used to produce an object from a flat sheet of metal, the shape of which cannot be developed. This technique is suitable for mass production.

The sheath 79 is a flexible sheath in this case, for example made of XS range 321 stainless steel in DN16 by Kenovel. In addition, the flexible conductive core 74 is, for example, 70 mm² multi-strand copper.

In addition, an electrically insulating jacket is advantageously added to the assembly 72 formed, as described above, in particular a Nefatex 1390 ceramic braided jacket (alumina-silica sheath with standard dielectric strength of 700 V at 1000° C.). Such an electrically insulating jacket is not shown in the examples described.

It should be noted that FIG. 9 also shows the soldering B between the connection strip 78 and the conductive core 74. A TIG weld (reference P) is made between the whistle 78 and the flexible sheath 79 to ensure a seal.

The method for assembling a “high conductivity” connection strip 78 or “high conductivity” whistle then comprises the following steps:
cleaning the constituent parts of the whistle 78, for example using detergents, solvents or any other appropriate means,
inserting the connection core 80 into the connection sheath 81,
inserting the tubular sleeve 82, made of the first metal material,
bonding the connection sheath 81 to the tubular sleeve 82 by TIG welding so as to seal the joints on each face, optionally with an added material in particular made of stainless steel,
adding parts 86 and 87 to the connection core 80: the part 86 is formed of the first material and provides mechanical retention between the connection sheath 81 and the flexible sheath 79, and protection against oxidation (seal continuity between 81 and 79); the part 87 is formed of the second material and provides the electrical connection between the connection core 80 and the conductive core 74,
adding the sealing cap 85 formed by a closing plate 83 and a sealing tube 84, as shown in FIG. 10,
bonding the connection sheath 81 to the sealing cap 85 by TIG welding in order to seal the joint,
evacuating the whistle 78, a vacuum pump being connected to the tube 84 so as to create a vacuum inside the connection sheath 81, then seal-welding the tube 84 so as to seal it hermetically and permanently.

Subsequently, a diffusion welding cycle by hot isostatic pressing (HIP) is applied with the following operating conditions:
heating the assembly 78 formed inter alia by the connection core 80 and the connection sheath 81 to a temperature comprised between 600° C. and 1060° C., preferably between 800° C. and 1000° C., in particular a temperature 920° C., of
applying a pressure comprised between 500 bar and 1500 bar, preferably between 800 bar and 1200 bar, in particular a pressure of 1020 bar, to the connection sheath 81,
applying a pressure and temperature plateau for a period of 30 minutes to several hours, preferably 1 hour to 3 hours, in particular 2 hours,
allowing the assembly to cool and depressurising.

Finally, each “high conductivity” connection strip 78 can be subjected to machining in order to enable the direct connection of the connection core 80, and a whistle 78 as shown in FIG. 11 is produced.

The “high conductivity” whistles 78 obtained are then connected to the assembly 72 by a low-resistivity connection. In particular, the conductive core 74 and the connection core 80 of each connection strip 78 can be connected by high-temperature brazing or soldering. This produces a high-conductivity electrical connection. The choice of filler metal may guarantee the connection up to maximum use temperatures of around 900° C. Assembly can be carried out, for example, using Castolin® 146 commercial soldering and brazing alloy and the recommended 146 M flux. This soldering and brazing alloy consists of 60% copper, 39% zinc and 1% tin-manganese.

Then, as described above, the mechanical connection and seal are obtained by TIG welding, as shown in FIG. 8 at the point P over the entire circumference, with an addition of material preferably made of the second metal material. A possible evacuation step can be carried out and a step of X-raying the welds and brazed joints can also be performed as described above.

The invention can be applied to a high-temperature steam electrolyser, to a high-temperature co-electrolyser supplied with a mixture of steam (H₂O) and carbon dioxide (CO₂), to a high-temperature solid oxide fuel cell, to a reversible high-temperature fuel cell and electrolyser system, to “medium-temperature” cells or electrolysers, i.e. 400° C., or proton ceramic fuel cells or PCFCs, as described above.

The invention can be applied to the systems described above operating at atmospheric pressure but also to systems under pressure.

Outside of the technical field of solid oxide electrochemical systems, the invention applies to all fields where there is a need for electrical conduction in an oxidising environment at high temperature or in conditions resulting in the rapid deterioration of electrically conductive materials.

Of course, the invention is not limited to the exemplary embodiments that have just been described. Various modifications may be made thereto by a person skilled in the art.

1. A flexible electrical conductor including:
an assembly comprising:
a flexible conductive core made of a first metal material, and
a sheath covering the conductive core and made of a second metal material having an electrical resistivity higher than the electrical resistivity of the first metal material, and
a first connection strip formed at least in part by the second metal material and connected to a first end of the assembly, wherein
at the first end of the assembly, the sheath and the first connection strip are bonded by TIG welding, and the conductive core and the first connection strip are bonded by fillet-brazing or soldering.

2. The conductor according to claim 1, further comprising:
a second connection strip formed at least in part by the second metal material and connected to a second end of the assembly,
wherein, at the second end of the assembly, the sheath and the second connection strip are bonded by TIG welding, and the conductive core and the second connection strip are bonded by fillet-brazing or soldering, the TIG welds at the two ends of the assembly and the sheath completely covering the conductive core over an entire length of the conducting core.

3. The conductor according to claim 1, wherein at least one gap is present between an outer surface of the conductive core and an inner surface of the sheath over at least part of a length of the conductive core.

4. The conductor according to claim 1, wherein the conductive core is made of copper, nickel, or silver and/or copper, nickel, or silver alloys.

5. The conductor according to claim 1, wherein the sheath is made of stainless or refractory metal and/or metal or refractory alloys.

6. The conductor according to claim 1, wherein the first connection strip and/or the second connection strip each has a conductive connection core made of the first metal material, and a connection sheath completely covering the connection core over an entire length of the connection core and made of the second metal material.

7. The conductor according to claim 1, wherein the assembly comprising the conductive core and the sheath is completely covered by an electrically insulating jacket.

8. A method for manufacturing an electrical conductor according to claim 1, the method comprising:
cleaning the surfaces using a detergent and/or a solvent, inserting the conductive core into the sheath,
bonding the conductive core to the first connection strip by fillet-brazing or soldering,
bonding the sheath to the first connection strip by TIG welding, and
if necessary, evacuating the sheath by pumping.

9. The method according to claim 8, wherein the electrical conductor has a second connection strip formed at least in part by the second metal material and connected to a second end of the assembly, and the method includes, after the step of bonding the sheath to the first connection strip by TIG welding, the following steps:
bonding the conductive core to the second connection strip by fillet-brazing or soldering, and
bonding the sheath to the second connection strip by TIG welding.

10. The method according to claim 8, wherein the first connection strip and/or the second connection strip are formed by assembling a conductive connection core and a connection sheath completely covering the connection core, the connection core being manufactured by die-forging and the connection sheath being manufactured by deep-drawing or assembling a plurality of parts made of the second metal material.

11. The method according to claim 10, wherein assembling the first connection strip and/or the second connection strip includes at least the following steps:
cleaning the constituent elements of the connection strip using a detergent or a solvent,
inserting the connection core into the connection sheath,
evacuating the connection strip, and
applying a diffusion welding cycle by hot isostatic pressing.

12. The method according to claim 11, wherein the diffusion welding cycle by hot isostatic pressing is carried out with the following operating conditions:
heating the assembly formed by the connection core and the connection sheath to a temperature comprised between 600° C. and 1060° C.,
applying a pressure comprised between 500 bar and 1500 bar to the connection sheath,
applying a pressure and temperature plateau for a period of 30 minutes to several hours, and
allowing the assembly to cool and depressurising.

13. The method according to claim 10, wherein the conductive core and the connection core of the first connection strip and/or of the second connection strip are joined together by a method of high-temperature brazing or soldering.

14. A method of using at least one electrical conductor according to claim 1, as an electrical conductor of an electrochemical system including:
an enclosure for the circulation of air in the volume delimited thereby, and
an electrochemical device housed in the enclosure, comprising:
a high-temperature SOEC/SOFC-type solid oxide stack of elementary electrochemical cells each comprising an electrolyte interposed between a cathode and an anode and connected in series between two electrical terminals, and
said at least one electrical conductor connected to at least one of the two electrical terminals.

15. An electrochemical system, comprising:
an enclosure for the circulation of air in the volume delimited thereby, and
an electrochemical device housed in the enclosure, comprising:
a high-temperature SOEC/SOFC-type solid oxide stack of elementary electrochemical cells, each comprising an electrolyte interposed between a cathode and an anode and connected in series between two electrical terminals, and
at least one electrical conductor according to claim 1, connected to at least one of the two electrical terminals.
